(19) United States
(12) Patent Application Publication
(10) Pub. No.: US 2022/0366479 A1
(43) Pub. Date: Nov. 17, 2022

(54) GENERIC FRAMEWORK FOR USING ASSIGNMENT AND CONTEXT DATA CONSTRUCTS TO PROVIDE A CUSTOMIZED EXPERIENCE

(71) Applicant: salesforce.com, inc., San Francisco, CA (US)

(72) Inventors: Scot DeDeo, Burlington, MA (US); Dilipkumar Patel, Burlington, MA (US); Pratik Nagar, Salt lake City, UT (US)

(21) Appl. No.: 17/321,647

(22) Filed: May 17, 2021

(51) Int. Cl. G06Q 30/06; G06F 16/958; H04L 29/06

(52) U.S. Cl. CPC G06Q 30/0641; G06F 16/986; H04L 63/0853

(57) ABSTRACT

Methods, computer readable media, and devices for a generic framework using assignment and context data constructs to provide a customized experience are disclosed. One method may include retrieving a first user context, including a set of user key:value pairs and information identifying a shopping location, based on a first user request received by a commerce platform, identifying a first assignment, including a set of assignment key:value pairs, information identifying an assignment location, and a set of assignment experiences defining a shopping experience, based on the first user context, and presenting the shopping experience to the first user. The method may further include retrieving a second user context based on a second user request, identifying a second assignment based on the second user context, and presenting a second shopping experience based on the second assignment.

### TECHNICAL FIELD

Embodiments disclosed herein relate to techniques and systems for a generic framework for using assignment and context data constructs to provide a customized experience.

### BACKGROUND

Generally, it may be desirable for the journey of an end user of an interactive platform such as a website to be context aware, which means the information available to the user accounts for information about the user. As a specific example, a technical user such as a support specialist, programmer, or the like may have a different journey through a help center than a non-technical end user, who may be more interested in user interface help than backend technical issues. Each user may have different journey through an automated help system or an enterprise help desk management system. It may be desirable for the system to be aware of the relevant context, such as the information presented, the platform and/or geographical location from which the user is accessing the system, what information they are requesting, or what technical changes they have made within the system, or the like, so as to customize future experiences for the same user. As another example, for an e-commerce shopper's journey through a site, it may be desirable for the products, prices, promotions, shipping methods, payment types, and the like that are available to the shopper to take into account what site the shopper is visiting, who the shopper is, where they are shopping from (geographical location, computer, mobile device, etc.) including technical specifications and limitations of particular locations and/or platforms, when they are shopping (or checking out), and any other details around their journey (coupons in cart, selected payment type, shipping method, and customer group membership). Recently there has been a rise in the need to personalize what is available to a shopper.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIG. 1A is a block diagram illustrating a system for use with a generic framework for using assignment and context data constructs to provide a customized experience according to some example implementations.

FIG. 1B is a block diagram illustrating a system for use with a generic framework for using assignment and context data constructs to provide a customized experience according to some example implementations.

FIG. 2 is a flow diagram illustrating a method for use with a generic framework for using assignment and context data constructs to provide a customized experience according to some example implementations.

FIG. 3A is a block diagram illustrating an electronic device according to some example implementations.

FIG. 3B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Embodiments disclosed herein provide techniques, systems, and devices that allow for a user's journey through a computerized system to be tailored to the individual user based on a variety of context data. Embodiments disclosed herein further provide a generic framework for constructs that allow for capture and manipulation of such data to provide a more tailored experience than may be possible in conventional computerized systems and/or conventional in-person equivalents. Such a framework may be applied in a range of environmental and computerized interactive systems, including websites and combined virtual/physical systems.

In one example, a shopper may prefer to shop online, but pick up any purchased item(s) in person from a physical store. In this example, the shopper may need to select the physical location and the merchant may want to provide additional incentives, such as a lower price and/or a promotional discount, in order encourage this option. However, the merchant may also want to restrict which locations support this pick up option and/or limit a date/time the shopper may pick up their order as well as link the pricing to that particular date/time.

In another example, a subset of customers may be allowed early access to certain products. For example, once a customer is authenticated to a website, the customer may be mapped to a customer group and product availability may be linked to such customer group mapping.

In yet another example, data around a shopper may be tracked by a commerce platform, such as a retail website. Through the use of statistics and/or machine learning, a shopper may be identified as part of one or more categories, such as frequent shopper, big spender, likely to purchase products under a certain price, or the like. Once attributes of the shopper have been identified, that context may be used to trigger a certain set of shopper specific discounts. Additionally, this may be utilized to increase the likelihood of a shopper converting their cart to an order.

In various implementations, a data construct, referred to as a shopper context, may be utilized to define a user and qualifiers or attributes of the user. Similarly, a data construct, referred to as an assignment, may be utilized to define a “shopping experience” and qualifiers of the experience. In one example, a shopper context may include an indication of a site (both physical and virtual) that the shopper is visiting, a date (or date range) for which the context is effective, and a set of key:value pairs describing the shopper (e.g., customer group membership(s), frequent shopper status, average product price, location of shopper, etc.). In this example, an assignment may include an indication of for which site(s) the assignment is available, an effective date (or date range) of the assignment, a shopping experience (e.g., available promotions, pricing, payment type(s), and shipping method(s)), and a set of key:value pairs defining qualifiers or conditions to be met for the assignment.

When a shopper visits a website, a shopper context may be assigned or otherwise associated with that shopper. Based on the shopper context, an assignment may also be assigned or otherwise associated with the shopper. Based on the assignment, the shopper may be presented with a particular shopping experience. Such shopping experience may include, for example, products available to the shopper, information about product availability, information about pricing, information about available promotions and/or discounts, payment types available to the shopper, available shipping methods (including pick up options), and the like.

In various implementations, an assignment data structure may include, for example, sites, experiences, qualifiers, an all qualifiers required flag, and a start and/or end date or date range. Sites may include, for example, an array of up to twenty sites for which an assignment may be active. Experiences may include, for example, up to twenty key:value pairs where a key may be an experience type (e.g., promotion/discount, payments, pricing, shipping method) and a value may be an array of up to 100 identifiers corresponding to the experience type (e.g., for a promotion/discount experience type key, the value may include P1, P2, . . . P100). Qualifiers may include, for example, up to twenty key:value pairs describing criteria of a shopper for which an assignment may be active (e.g., device type=mobile). The all qualifiers flag may be a boolean flag indicating whether all qualifiers may be required in order to activate an assignment for a shopper. The start and/or end date or data range may indicate a beginning and/or ending date (or date range) for when an assignment may be active.

In various implementations, a shopper context data structure may include, for example, site, effective date, and qualifiers. Site may include, for example, an indication of a site the shopper is currently visiting. Effective date may include, for example, a date (either past, current, or future) or date range for when the shopper context may be active. The effective date may enable, for example, shopping for checkout at a future date/time. Qualifiers may include, for example, up to twenty key:value pairs describing a shopper.

In one example, a shopper may be presented with store specific inventory, pricing, promotions, and shipping/pick up options based on a particular checkout date selected by the shopper. In this example, an assignment may be defined to trigger the inventory, pricebooks, promotions, and shipping options based on the site and the qualifier of store identifier. In addition, a start and end date, based on the selected checkout date, may be used to restrict when these options are valid. In particular, the assignment may include the following:

| | |
|---|---|
| Sites | |
| | Site 1 |
| Qualifiers | |
| | Store = Store 1 |
| Experiences | |
| | Inventory = Store 1 Inventory |
| | Prices = Store 1 Pricebook January 2021 Week 1 |
| | Promotions = Store 1 Promotion 1, Store 1 Promotion 2 |
| | Shipping Methods = Store 1 Shipping, Store 1 Pick |
| | Up In Store |
| Start Date | |
| | Jan. 1, 2021 0:00:00 |
| End Date | |
| | Jan. 7, 2021 0:00:00 |

Further in this example, a shopper context that may activate the above assignment may include the following:

| | |
|---|---|
| Site | |
| | Site 1 |
| Qualifiers | |
| | Store = Store 1 |
| Effective Date | |
| | Jan. 7, 2021 0:00:00 |

In another example, only certain products may be available to a particular group of customers. For example, a shopper may need to be authenticated and, based on that authentication, the shopper may be identified as belonging to a particular group with access to certain products. In this example, the assignment may include the following:

| | |
|---|---|
| Sites | |
| | Site 1 |
| Qualifiers | |
| | Customer Group = Platinum Customers |
| Experiences | |
| | Product Category = Early Access Products |

Further in this example, a shopper context that may activate the above assignment may include the following:

| | |
|---|---|
| Site | |
| | Site 1 |
| Qualifiers | |
| | Customer Group = Platinum Customers |

In yet another example, promotional discounts may be available to frequent shoppers that purchase products priced at $100 or less. For example, a shopper may be identified as a frequent shopper and a P95 products price associated with the shopper may be determined to be $100. In this example, the assignment may include the following:

| | |
|---|---|
| Sites | |
| | Site 1 |
| Qualifiers | |
| | Frequent Shopper = true |
| | p95 Product Price = $100 |
| All | |
| Qualifiers | |
| Required | |
| | true |
| Experiences | |
| | Promotion = Fixed Price Discount $100 |
| | for Select Products |

Further in this example, a shopper context that may activate the above assignment may include the following:

| | |
|---|---|
| Site | |
| | Site 1 |
| Qualifiers | |
| | Frequent Shopper = true |
| | Avg Product Price = $100 |

Implementations of the disclosed subject matter provide methods, computer readable media, and devices for a generic framework for using assignment and context data constructs to provide a customized experience. In various implementations, a method may include retrieving, by a server, a first user context based on a first user request received by a commerce platform from a first user. The first user context may include information identifying a first shopping location of the first user and a set of user key:value pairs representing criteria associated with the first user. The method may further include identifying a first assignment based on the first user context. The first assignment may include information identifying a location of the first assignment, a set of assignment key:value pairs representing criteria associated with the first assignment, and a set of assignment experiences defining a first shopping experience of the commerce platform available to the first user. The method may also include presenting, via a graphical user interface, the first shopping experience of the commerce platform to the first user, retrieving a second user context based on a second user request received by the commerce platform, identifying a second assignment based on the second user context, and presenting a second shopping experience of the commerce platform based on the second assignment.

In some implementations, the second user request may be received from a second user, the second context may include a set of user key:value pairs representing criteria associated with the second user and information identifying a shopping location of the second user, the second assignment may include information identifying a location of the second assignment, a set of assignment key:value pairs representing criteria associated with the second assignment, and a set of assignment experiences defining the second shopping experience of the commerce platform, and presenting the second shopping experience of the commerce platform based on the second assignment may further include presenting the second shopping experience to the second user.

In some implementations, the second user request may be received from the first user, the second user context may include a set of user key:value pairs and information identifying a second shopping location of the first user, the second assignment may include information identifying a location of the second assignment, a set of assignment key:value pairs representing criteria associated with the second assignment, and a set of assignment experiences defining the second shopping experience of the commerce platform, and presenting the second shopping experience of the commerce platform based on the second assignment may further include presenting the second shopping experience to the first user.

In some implementations, the set of user key:value pairs of the second user context may be different than the set of user key:value pairs of the first user context.

In some implementations, the set of user key:value pairs may include one or more elements selected from the list consisting of: a geographical location; a device type; a time of day; a group membership; a shipping method; and a payment method.

In some implementations, the set of assignment key:value pairs may include one or more elements selected from the list consisting of: a geographical location; a device type; a time of day; a group membership; a shipping method; and a payment method.

In some implementations, the set of assignment experiences may include one or more elements selected from the list consisting of: a product catalog; a price book; a promotion; a shipping method; and a checkout date.

In various implementations, identifying the first assignment based on the first user context may include comparing the information identifying the first shopping location of the first user and the set of user key:value pairs of the first user context with each of a plurality of assignments and identifying the first assignment based on a match of the information identifying the first shopping location of the first user with the information identifying the location of the first assignment and the set of user key:value pairs of the first user context with the set of assignment key:value pairs of the first assignment.

In various implementations, the method may further include generating a javascript object notation (JSON) web token (JWT) by authenticating the first user with the commerce platform and providing the JWT to the first user. In some implementations, the JWT may include a user identifier of the first user.

In some implementations, the first user request may include the JWT, retrieving the first user context based on the first user request received by the commerce platform from the first user may include validating the JWT and retrieving the first user context based on the user identifier of the first user, and identifying the first assignment based on the first user context may include validating the JWT and identifying the first assignment based on the user identifier of the first user.

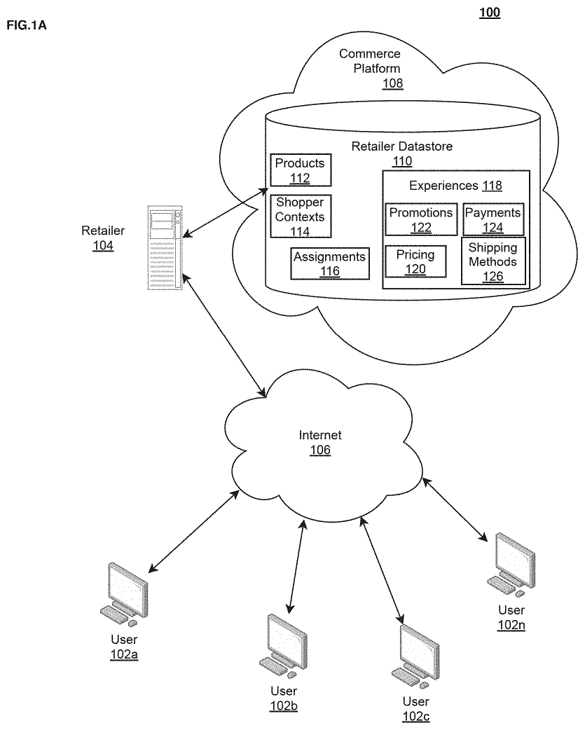

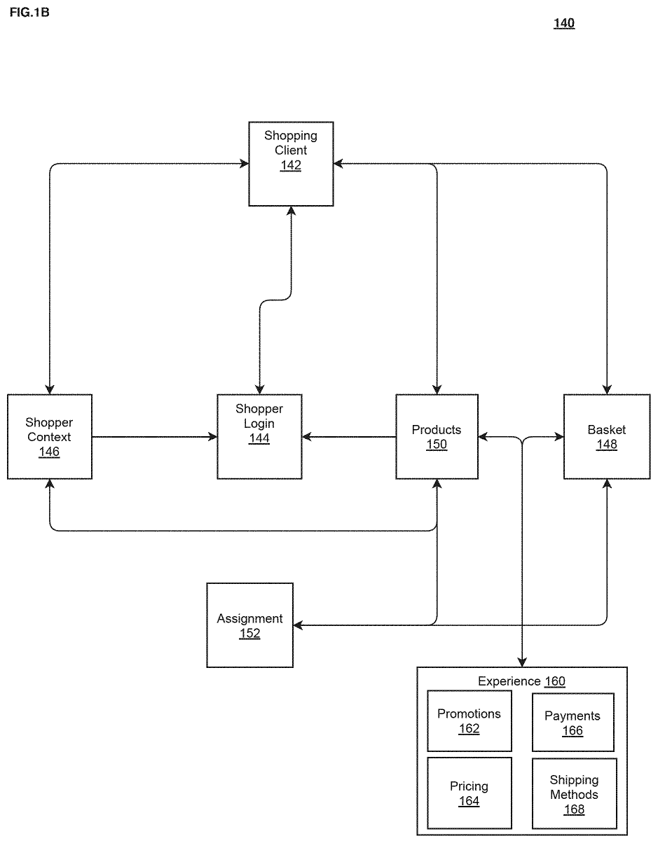

FIG. 1A illustrates a system 100 for use with a generic framework for using assignment and context data constructs to provide a customized experience according to various implementations of the subject matter disclosed herein. In various implementations, the system 100 may include, for example, users 102a . . . n that access or otherwise connect with retailer or other provider 104 via the Internet 106. Retailer 104 may utilize or otherwise have access to a computerized user experience platform, such as a commerce platform 108, which may include storage media, such as retailer datastore 110. Retailer datastore 110 may include, for example, products 112, shopper contexts 114, assignments 116, and experiences 118. Experiences 118 may include, for example, promotions 122, payments 124, pricing 120, and shipping methods 126. More generally, embodiments disclosed herein may be applied to a range of computerized systems that provide information and/or usable interfaces to execute various actions to end users. For example, instead of an e-commerce platform, platform 108 may be a computerized management system that allows a user to access and control various devices within the system, such as remote datacenters and servers, firewalls, and the like.

In one example, retailer 104 may be a merchant that provides online shopping tools and 102a . . . n may be customers of the merchant. Although not shown, the merchant may also provide in person shopping services, such as via one or more physical stores. In this example, products 112 may include information about the various products and/or services offered by retailer 104. However, not all products and/or services may be offered to every customers and/or information about a particular product and/or service may differ for different customers.

In various implementations, shopper contexts 114 may include, for example, a collection of shopper context data constructs, with any one shopper context data construct corresponding to one customer. For example, one shopper context data construct may correspond to user 102a while a different shopper context data construct may correspond to user 102b. Similarly, in various implementations, assignments 116 may include, for example, a collection of assignment data constructs, with any one assignment data construct corresponding to a shopping experience to be provided by commerce platform 108 to a customer. A particular shopping experience may be defined, for example, based on information included in or otherwise provided by promotions 122, payments 124, pricing 120, and/or shipping methods 126. As such, experiences 118 does not include individual experiences, per se. Rather, experiences 118 includes various collections of information on which individual experiences, such as shopping, customer support, information retrieval, or the like, may be based.

Promotions 122 may include, for example, a collection of various promotions and/or discounts to be associated with various products, such as products 112 of retailer 104. Payments 124 may include, for example, a collection of various payment types to be offered by a merchant, such as retailer 104. Pricing 120 may include, for example, a collection of various prices for the various products and/or services offered by a merchant. Shipping methods 126 may include, for example, a collection of various shipping and/or pick up methods offered by a merchant. Based on an assignment data construct, as stored in assignments 116, commerce platform 108 may enable retailer 104 to provide a customized shopping experience to any one customer by utilizing a selection of information from any one or more of pricing 120, promotions 122, payments 124, and shipping method 126. By utilizing a shopper context data construct, such as contained in shopper contexts 114, and an assignment data construct, such as contained in assignments 116, a merchant, such as retailer 104, may be able to present customized shopping experiences on a larger scale while reducing computing resources, thereby improving the overall performance of a computing platform, such as commerce platform 108.

FIG. 1B illustrates a system 140 for use with a generic framework for using assignment and context data constructs to provide a customized experience according to various implementations of the subject matter disclosed herein. In particular, while system 100 of FIG. 1A may be presented from a large-scale perspective (multiple users, multiple shopper contexts, multiple assignments, etc.), system 140 of FIG. 1B may be presented from the perspective of a single user.

In various implementations, a user (i.e., shopping customer) may interact with shopping client 142 in order to perform shopping functions. Shopping client 142 may be, for example, an application executing on a computing device (e.g., laptop, desktop, mobile phone, tablet, or the like) operated by the user and/or a web interface provided to the user via a web browser of the computing device. Shopping client 142 may, for example, interact with shopper login 144 in order to authenticate or otherwise authorize the user. As part of this authentication process, shopper login 144 may generate a javascript object notation (JSON) web token (JWT) and provide this JWT to shopping client 142. The JWT may include, for example, a user identifier of the user. The JWT or some portions of the JWT may, for example, be encrypted or otherwise encoded such that the user, or some other third party, is unable to modify or manipulate the JWT.

Shopping client 142 may, for example, interact with shopper context 146 in order to create, modify, or otherwise update a shopping context corresponding to the user. In some implementations, shopping client 142 may provide the JWT, as provided by shopper login 144, to shopper context 146 and shopper context 146 may, in turn, provide the JWT to shopper login 144 in order to validate that the user is able to manipulate the corresponding shopping context.

Shopping client 142 may, for example, interact with products 150 and/or basket 148. Such interaction with products 150 may be to generate a listing or otherwise provide information about products and/or services available to the user. Likewise, such interaction with basket 148 may be to create, modify, or otherwise maintain a basket or shopping cart on behalf of the user. In some implementations, shopping client 142 may provide the JWT as part of the interaction with products 150. In turn, products 150 may, for example, utilize the JWT to validate the user. Alternatively, or in addition, products 150 may utilize the JWT as part of an interaction with shopper context 146 in order to identify the shopper context corresponding to the user.

Products 150 and/or basket 148 may, for example, interact with assignment 152 in order to identify an assignment to be active while interacting with shopping client 142. In some implementations, the assignment may be identified based on the shopper context corresponding to the user. Based on the identified assignment, products 150 and/or basket 148 may, for example, interact with experience 160 in order to define a shopping experience to be provided to the user. For example, experience 160, based on the identified assignment, may provide some selection of information about promotions from promotions 162, some selection of information about pricing from pricing 164, some selection of information about payment types from payments 166, and/or some selection of information about shipping or pick up options from shipping methods 168. These various selections of information may define, for example, a shopping experience to be provided to the user by shopping client 142. In this way, the user may experience shopping that is customized to the user.

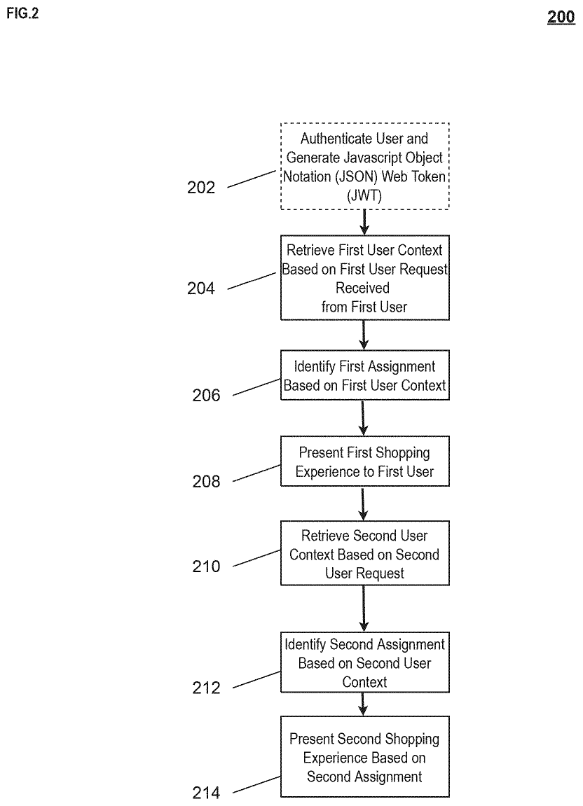

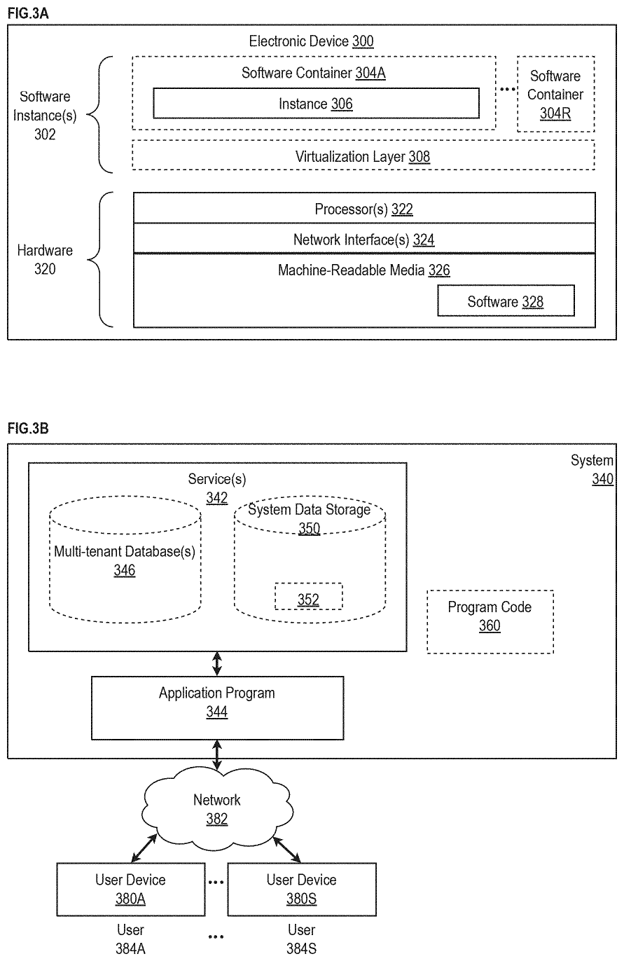

FIG. 2 illustrates a method 200 for using a generic framework for using assignment and context data constructs to provide a customized experience, as disclosed herein. In various implementations, the steps of method 200 may be performed by a server, such as electronic device 300 of FIG. 3A or system 340 of FIG. 3B, and/or by software executing on a server or distributed computing platform. Although the steps of method 200 are presented in a particular order, this is only for simplicity.

In optional step 202, a user may be authenticated and a javascript object notation (JSON) web token (JWT) may be generated on behalf of the authenticated user. For example, the user may be prompted to provide user credentialed and, based on the provided credentialed, the user may be authenticated. In various implementations, the JWT may include, for example, a user identifier of the user. In some implementations, the JWT or some portion(s) of the JWT may be, for example, encrypted or otherwise encoded such that the user or some other 3^{rd}-party may not modify or otherwise manipulate the JWT.

In step 204, a first user context may be retrieved based on a first user request from a first user. In various implementations, the first user context may be retrieved by a server or other component of a commerce platform, such as commerce platform 108 of FIG. 1A. The first user request may include, for example, a user identifier and such user identifier may be used to retrieve a user context corresponding to the first user. In some implementations, the first user request may include the JWT generated in optional step 202. In various implementations, the first user context may include, for example, information identifying a first shopping location of the first user and a set of user key:value pairs representing criteria associated with the first user. The set of user key:value pairs may include, for example, a geographical location of the user, a device type of the user, a time of day, a group membership of the user, a shipping method, a payment method, or the like.

In step 206, a first assignment may be identified based on the first user context. For example, the information identifying the first shopping location and/or some or all of the information in the set of user key:value pairs included in the first user context may be utilized to identify the first assignment. In various implementations, the first assignment may include, for example, information identifying a location of the first assignment, a set of assignment key:value pairs representing criteria associated with the first assignment, and a set of assignment experiences defining a first shopping experience of the commerce platform available to the first user. In some implementations, the set of assignment key:value pairs may include, for example, a geographical location of a user, a device type of a user, a time of day, a group membership of a user, a shipping method, a payment method, or the like. In some implementations, the set of assignment experiences may include, for example, a product catalog, a price book, a promotion, a shipping method, a checkout date, or the like. In some implementations, identifying the first assignment based on the first user context may include, for example, matching information from the user context with information from the assignment.

In step 208, a first shopping experience may be presented to the first user. For example, based on the identified first assignment, the first shopping experience may be presented to the first user via a graphical user interface.

In step 210, a second user context may be retrieved based on a second user request. Such second user request may be received from the first user or from a different second user. If the second user request is received from a second user, the retrieved second user context may include, for example, information identifying a shopping location of the second user and a set of user key:value pairs representing criteria associated with the second user. If the second user request is received from the first user, the retrieved second user context may include, for example, information identifying a second shopping location of the first user and a set of user key:value pairs which may be the same as or different from the set of user key:value pairs included in the first user context.

In step 212, a second assignment may be identified based on the second user context. In various implementations, the second assignment may include, for example, information identifying a location of the second assignment, a set of assignment key:value pairs representing criteria associated with the second assignment, and a set of assignment experiences defining a second shopping experience of the commerce platform. In some implementations, identifying the second assignment based on the second user context may include, for example, matching information from the user context with information from the assignment.

Of note, while the first and second user contexts may represent the same or different users, the first and second assignments may represent different shopping experiences provided by a single merchant. For example, a first user may prefer to pick up certain items in person from a physical location of a merchant (e.g., first user context for first user and first assignment) and have certain items shipped from the merchant's warehouse (e.g., second user context for first user and second assignment) while a second user may not have a shipping preference (e.g., second user context for second user and second assignment). Alternatively, or in addition, a commerce platform may provide services on behalf of multiple merchants and the first and second assignments may represent shopping experiences provided by different merchants. For example, a user may shop at a first merchant (e.g., first user context and first assignment) and then visit another merchant (e.g., second user context and second assignment).

In step 214, the second shopping experience may be presented based on the second assignment. For example, based on the identified second assignment, the second shopping experience may be presented to a user via a graphical user interface.

As disclosed herein, an assignment data construct may describe an “experience” and “qualifiers” necessary to activate such experience. Such “experience” may define what is available to a user (i.e., what will be experienced) and such “qualifiers” may define the criteria necessary to qualify for the experience. Similarly, a context data construct may describe an individual user and qualifiers of such individual. Based on an individual context and an individual assignment, a customized experience, such as customer support, shopping, information retrieval, or the like, may be provided to an individual. By utilizing these assignment and context data constructs, personalized experiences may be provided on a highly scalable basis while reducing computing resources otherwise needed for such customized experiences. Reducing the amount of required computing resources improves the overall performance of the computing platform used to provide various services, such as information retrieval, shopping, customer support, and the like.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 3A is a block diagram illustrating an electronic device 300 according to some example implementations. FIG. 3A includes hardware 320 comprising a set of one or more processor(s) 322, a set of one or more network interfaces 324 (wireless and/or wired), and machine-readable media 326 having stored therein software 328 (which includes instructions executable by the set of one or more processor(s) 322). The machine-readable media 326 may include non-transitory and/or transitory machine-readable media. Each of the previously described clients and consolidated order manager may be implemented in one or more electronic devices 300.

During operation, an instance of the software 328 (illustrated as instance 306 and referred to as a software instance; and in the more specific case of an application, as an application instance) is executed. In electronic devices that use compute virtualization, the set of one or more processor(s) 322 typically execute software to instantiate a virtualization layer 308 and one or more software container(s) 304A-304R (e.g., with operating system-level virtualization, the virtualization layer 308 may represent a container engine running on top of (or integrated into) an operating system, and it allows for the creation of multiple software containers 304A-304R (representing separate user space instances and also called virtualization engines, virtual private servers, or jails) that may each be used to execute a set of one or more applications; with full virtualization, the virtualization layer 308 represents a hypervisor (sometimes referred to as a virtual machine monitor (VMM)) or a hypervisor executing on top of a host operating system, and the software containers 304A-304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 328 is executed within the software container 304A on the virtualization layer 308. In electronic devices where compute virtualization is not used, the instance 306 on top of a host operating system is executed on the “bare metal” electronic device 300. The instantiation of the instance 306, as well as the virtualization layer 308 and software containers 304A-304R if implemented, are collectively referred to as software instance(s) 302.

Alternative implementations of an electronic device may have numerous variations from that described above. For example, customized hardware and/or accelerators might also be used in an electronic device.

FIG. 3B is a block diagram of a deployment environment according to some example implementations. A system 340 includes hardware (e.g., a set of one or more server devices) and software to provide service(s) 342, including a consolidated order manager. In some implementations the system 340 is in one or more datacenter(s). These datacenter(s) may be: 1) first party datacenter(s), which are datacenter(s) owned and/or operated by the same entity that provides and/or operates some or all of the software that provides the service(s) 342; and/or 2) third-party datacenter(s), which are datacenter(s) owned and/or operated by one or more different entities than the entity that provides the service(s) 342 (e.g., the different entities may host some or all of the software provided and/or operated by the entity that provides the service(s) 342). For example, third-party datacenters may be owned and/or operated by entities providing public cloud services.

The system 340 is coupled to user devices 380A-380S over a network 382. The service(s) 342 may be on-demand services that are made available to one or more of the users 384A-384S working for one or more entities other than the entity which owns and/or operates the on-demand services (those users sometimes referred to as outside users) so that those entities need not be concerned with building and/or maintaining a system, but instead may make use of the service(s) 342 when needed (e.g., when needed by the users 384A-384S). The service(s) 342 may communicate with each other and/or with one or more of the user devices 380A-380S via one or more APIs (e.g., a REST API). In some implementations, the user devices 380A-380S are operated by users 384A-384S, and each may be operated as a client device and/or a server device. In some implementations, one or more of the user devices 380A-380S are separate ones of the electronic device 300 or include one or more features of the electronic device 300.

In some implementations, the system 340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 340 is a multi-tenant cloud computing architecture supporting multiple services, such as one or more of the following types of services: Customer relationship management (CRM); Configure, price, quote (CPQ); Business process modeling (BPM); Customer support; Marketing; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 340 may include an application platform 344 that enables PAAS for creating, managing, and executing one or more applications developed by the provider of the application platform 344, users accessing the system 340 via one or more of user devices 380A-380S, or third-party application developers accessing the system 340 via one or more of user devices 380A-380S.

In some implementations, one or more of the service(s) 342 may use one or more multi-tenant databases 346, as well as system data storage 350 for system data 352 accessible to system 340. In certain implementations, the system 340 includes a set of one or more servers that are running on server electronic devices and that are configured to handle requests for any authorized user associated with any tenant (there is no server affinity for a user and/or tenant to a specific server). The user devices 380A-380S communicate with the server(s) of system 340 to request and update tenant-level data and system-level data hosted by system 340, and in response the system 340 (e.g., one or more servers in system 340) automatically may generate one or more Structured Query Language (SQL) statements (e.g., one or more SQL queries) that are designed to access the desired information from the multi-tenant database(s) 346 and/or system data storage 350.

In some implementations, the service(s) 342 are implemented using virtual applications dynamically created at run time responsive to queries from the user devices 380A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 344 includes an application setup mechanism that supports application developers' creation and management of applications, which may be saved as metadata by save routines. Invocations to such applications, including the framework for modeling heterogeneous feature sets, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 340 and the user devices 380A-380S.

Each user device 380A-380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 340. For example, the user interface device can be used to access data and applications hosted by system 340, and to perform searches on stored data, and otherwise allow one or more of users 384A-384S to interact with various GUI pages that may be presented to the one or more of users 384A-384S. User devices 380A-380S might communicate with system 340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 380A-380S might include an HTTP client, commonly referred to as a “browser,” for sending and receiving HTTP messages to and from server(s) of system 340, thus allowing users 384A-384S of the user devices 380A-380S to access, process and view information, pages and applications available to it from system 340 over network 382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented method comprising:
retrieving, by a server, a first user context based on a first user request received by a commerce platform from a first user, the first user context comprising:
a set of user key:value pairs, each key:value pair representing a criteria associated with the first user; and
information identifying a first shopping location of the first user;
identifying a first assignment based on the first user context, the first assignment comprising:
information identifying a location of the first assignment;
a set of assignment key:value pairs, each key:value pair representing a criteria associated with the first assignment; and
a set of assignment experiences defining a first shopping experience of the commerce platform available to the first user;
presenting, via a graphical user interface, the first shopping experience of the commerce platform to the first user;
retrieving a second user context based on a second user request received by the commerce platform;
identifying a second assignment based on the second user context; and
presenting a second shopping experience of the commerce platform based on the second assignment.

2. The computer-implemented method of claim 1, wherein:
the second user request is received from a second user;
the second user context comprises:
a set of user key:value pairs, each key:value pair representing a criteria associated with the second user; and
information identifying a shopping location of the second user;
the second assignment comprises:
information identifying a location of the second assignment;
a set of assignment key:value pairs, each key:value pair representing a criteria associated with the second assignment; and
set of assignment experiences defining the second shopping experience of the commerce platform; and
presenting the second shopping experience of the commerce platform based on the second assignment further comprises presenting the second shopping experience to the second user.

3. The computer-implemented method of claim 1, wherein:
the second user request is received from the first user;
the second user context comprises:
a set of user key:value pairs; and
information identifying a second shopping location of the first user;
the second assignment comprises:
information identifying a location of the second assignment;
a set of assignment key:value pairs, each key:value pair representing a criteria associated with the second assignment; and
a set of assignment experiences defining the second shopping experience of the commerce platform; and
presenting the second shopping experience of the commerce platform based on the second assignment further comprises presenting the second shopping experience to the first user.

4. The computer-implemented method of claim 3, wherein the set of user key:value pairs of the second user context is different than the set of user key:value pairs of the first user context.

5. The computer-implemented method of claim 1, wherein the set of user key:value pairs comprises one or more elements selected from the list consisting of:
a geographical location;
a device type;
a time of day;
a group membership;
a shipping method; and
a payment method.

6. The computer-implemented method of claim 1, wherein the set of assignment key:value pairs comprises one or more elements selected from the list consisting of:
a geographical location;
a device type;
a time of day;
a group membership;
a shipping method; and
a payment method.

7. The computer-implemented method of claim 1, wherein the set of assignment experiences comprises one or more elements selected from the list consisting of:
a product catalog;
a price book;
a promotion;
a shipping method; and
a checkout date.

8. The computer-implemented method of claim 1, wherein identifying the first assignment based on the first user context comprises:
comparing the information identifying the first shopping location of the first user and the set of user key:value pairs of the first user context with each of a plurality of assignments; and
identifying the first assignment based on a match of:
the information identifying the first shopping location of the first user with the information identifying the location of the first assignment; and
the set of user key:value pairs of the first user context with the set of assignment key:value pairs of the first assignment.

9. The computer-implemented method of claim 1, further comprising:
generating a javascript object notation (JSON) web token (JWT) by authenticating the first user with the commerce platform, the JWT comprising a user identifier of the first user; and
providing the JWT to the first user.

10. The computer-implemented method of claim 9, wherein:
the first user request comprises the JWT;
retrieving the first user context based on the first user request received by the commerce platform from the first user comprises:
validating the JWT; and
retrieving the first user context based on the user identifier of the first user; and
identifying the first assignment based on the first user context comprises:
validating the JWT; and
identifying the first assignment based on the user identifier of the first user.

11. A non-transitory machine-readable storage medium that provides instructions that, if executed by a processor, are configurable to cause the processor to perform operations comprising:
retrieving, by a server, a first user context based on a first user request received by a commerce platform from a first user, the first user context comprising:
a set of user key:value pairs, each key:value pair representing a criteria associated with the first user; and
information identifying a first shopping location of the first user;
identifying a first assignment based on the first user context, the first assignment comprising:
information identifying a location of the first assignment;
a set of assignment key:value pairs, each key:value pair representing a criteria associated with the first assignment; and
a set of assignment experiences defining a first shopping experience of the commerce platform available to the first user;
presenting, via a graphical user interface, the first shopping experience of the commerce platform to the first user;
retrieving a second user context based on a second user request received by the commerce platform;
identifying a second assignment based on the second user context; and
presenting a second shopping experience of the commerce platform based on the second assignment.

12. The non-transitory machine-readable storage medium of claim 11, wherein:
the second user request is received from a second user;
the second user context comprises:
a set of user key:value pairs, each key:value pair representing a criteria associated with the second user; and
information identifying a shopping location of the second user;
the second assignment comprises:
information identifying a location of the second assignment;
a set of assignment key:value pairs, each key:value pair representing a criteria associated with the second assignment; and
a set of assignment experiences defining the second shopping experience of the commerce platform; and
presenting the second shopping experience of the commerce platform based on the second assignment further comprises presenting the second shopping experience to the second user.

13. The non-transitory machine-readable storage medium of claim 11, wherein:
the second user request is received from the first user;
the second user context comprises:
a set of user key:value pairs; and
information identifying a second shopping location of the first user;
the second assignment comprises:
information identifying a location of the second assignment;
a set of assignment key:value pairs, each key:value pair representing a criteria associated with the second assignment; and
a set of assignment experiences defining the second shopping experience of the commerce platform; and
presenting the second shopping experience of the commerce platform based on the second assignment further comprises presenting the second shopping experience to the first user.

14. The non-transitory machine-readable storage medium of claim 13, wherein the set of user key:value pairs of the second user context is different than the set of user key:value pairs of the first user context.

15. The non-transitory machine-readable storage medium of claim 11, wherein identifying the first assignment based on the first user context comprises:
comparing the information identifying the first shopping location of the first user and the set of user key:value pairs of the first user context with each of a plurality of assignments; and
identifying the first assignment based on a match of:
the information identifying the first shopping location of the first user with the information identifying the location of the first assignment; and
the set of user key:value pairs of the first user context with the set of assignment key:value pairs of the first assignment.

16. An apparatus comprising:
a processor; and
a non-transitory machine-readable storage medium that provides instructions that, if executed by a processor, are configurable to cause the processor to perform operations comprising:
retrieving, by a server, a first user context based on a first user request received by a commerce platform from a first user, the first user context comprising:
a set of user key:value pairs, each key:value pair representing a criteria associated with the first user; and
information identifying a first shopping location of the first user;
identifying a first assignment based on the first user context, the first assignment comprising:
information identifying a location of the first assignment;
a set of assignment key:value pairs, each key:value pair representing a criteria associated with the first assignment; and
a set of assignment experiences defining a first shopping experience of the commerce platform available to the first user;
presenting, via a graphical user interface, the first shopping experience of the commerce platform to the first user;
retrieving a second user context based on a second user request received by the commerce platform;
identifying a second assignment based on the second user context; and
presenting a second shopping experience of the commerce platform based on the second assignment.

17. The apparatus of claim 16, wherein:
the second user request is received from a second user;
the second user context comprises:
a set of user key:value pairs, each key:value pair representing a criteria associated with the second user; and
information identifying a shopping location of the second user;
the second assignment comprises:
information identifying a location of the second assignment;
a set of assignment key:value pairs, each key:value pair representing a criteria associated with the second assignment; and
a set of assignment experiences defining the second shopping experience of the commerce platform; and
presenting the second shopping experience of the commerce platform based on the second assignment further comprises presenting the second shopping experience to the second user.

18. The apparatus of claim 16, wherein:
the second user request is received from the first user;
the second user context comprises:
a set of user key:value pairs; and
information identifying a second shopping location of the first user;
the second assignment comprises:
information identifying a location of the second assignment;
a set of assignment key:value pairs, each key:value pair representing a criteria associated with the second assignment; and
a set of assignment experiences defining the second shopping experience of the commerce platform; and
presenting the second shopping experience of the commerce platform based on the second assignment further comprises presenting the second shopping experience to the first user.

19. The apparatus of claim 18, wherein the set of user key:value pairs of the second user context is different than the set of user key:value pairs of the first user context.

20. The apparatus of claim 16, wherein identifying the first assignment based on the first user context comprises:
comparing the information identifying the first shopping location of the first user and the set of user key:value pairs of the first user context with each of a plurality of assignments; and
identifying the first assignment based on a match of:
the information identifying the first shopping location of the first user with the information identifying the location of the first assignment; and
the set of user key:value pairs of the first user context with the set of assignment key:value pairs of the first assignment.
